(19) United States
(12) Patent Application Publication
(10) Pub. No.: US 2009/0163052 A1
(43) Pub. Date: Jun. 25, 2009

(54) Board to board connector with low board mounting profile

(75) Inventor: Yu Zhu, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/317,532

(22) Filed: Dec. 26, 2008

(30) Foreign Application Priority Data
Dec. 25, 2007 (CN) 200720129680.2

(51) Int. Cl. H01R 12/00

(52) U.S. Cl. 439/74; 439/80

(57) ABSTRACT

A board to board connector (1) comprising an insulating housing (2) and a plurality of terminals (3) formed on said insulating housing (2), said connector (1) forms two offset mating faces (251, 252) in relative inside of the insulating housing (2), and each terminal (3) forms two elastic-ends (31, 32) protruded from said mating faces (251, 252). When assembling, the board to board connector (1) can receive two circuit boards in the first mating face (251) and the second mating face (252), because of this offset board to board connector (1) design, the two boards can be lied spreadably, so that the total height of board mounting profile will be improved.

### BACKGROUND OF THE INVENTION

1. Field of the Invention

The present invention relates to a board to board electrical connector, and more particularly to a board to board electrical connector with low board mounting profile. The instant invention relates to the copending application Ser. No. 12/313,168 filed on Nov. 17, 2008 having the same inventor and the same assignee with the instant invention.

2. Description of Related Art

Board to board connector, which is widely used for interconnecting circuits between two parallel boards, has been asked for smaller size and lower board mounting profile.

U.S. Pat. No. 5,395,250 issued to Englert, Jr. et al on Mar. 7, 1995 discloses a board to board connector. According to Englert, Jr., said board to board connector 20 including a receptacle 22 and a plug 70, each having a housing 24, 72 with respective arrays of improved contacts 44, 92 secured therein, the contacts 44, 92 being of thin metal set on edge in the housings 24, 72 and including edge contact surfaces 50, 98 projecting from the housings 24, 72 in a common plane for soldering to the circuits. Upon mating of the receptacle 22 and plug 70, said board to board connector 20 can be resulted in low profile. While in this face to face board mounting, the distance between two parallel boards are limited by the height of housings 24, 72.

Hence, a board to board connector with low board mounting profile is highly desired to overcome the disadvantages of the related arts.

### SUMMARY OF THE INVENTION

Accordingly, the object of the present invention is to provide a board to board connector with low board mounting profile.

In order to achieve the object set forth, a board to board connector comprising an insulating housing and a plurality of terminals formed on said insulating housing, said connector forms two offset mating faces in relative inside of the insulating housing, and each terminal forms two elastic-ends protruded from said mating faces, when assembling, the board to board connector can receive two circuit boards in the first mating face and the second mating face, because of this offset board to board connector design, the two boards can be lied spreadably, so that the total height of board mounting profile will be improved.

Other objects, advantages and novel features of the invention will become more apparent from the following detailed description when taken in conjunction with the accompanying drawings.

### BRIEF DESCRIPTION OF THE DRAWINGS

FIG. 1 is an exploded, perspective view of the board to board connector of an embodiment of the present invention;

FIG. 2 is an assembled, perspective view of the board to board connector as shown in FIG. 1;

FIG. 3 is a cross-section view taken along line 3-3 of FIG. 2 with circuit boards mounted;

FIG. 4 is another exploded, perspective view of the board to board connector of an embodiment of the present invention;

FIG. 5 is another exploded, perspective view of the board to board connector of an embodiment of the present invention.

### DETAILED DESCRIPTION OF THE INVENTION

Reference will now be made in detail to the preferred embodiment of the present invention.

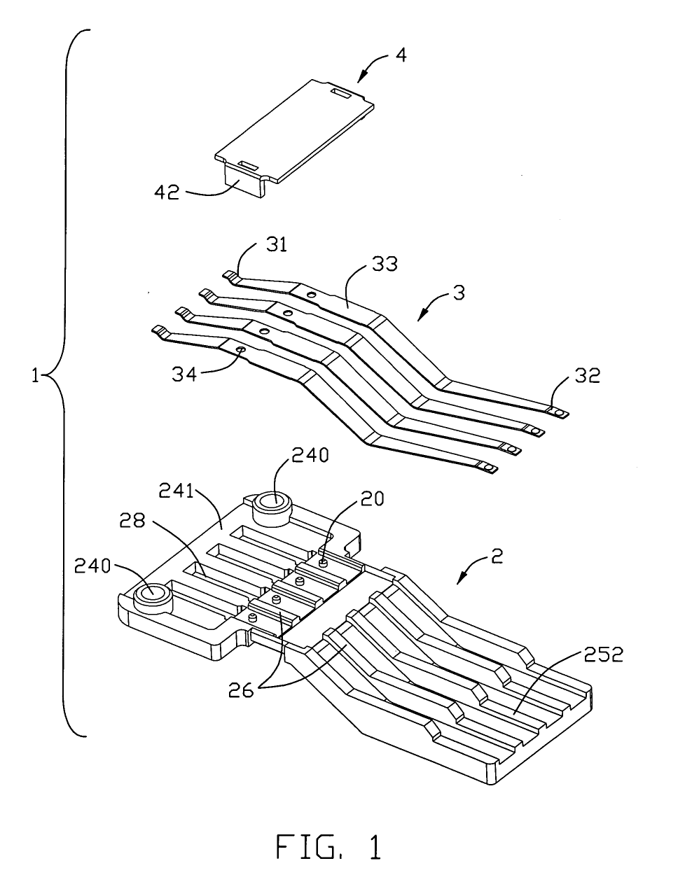

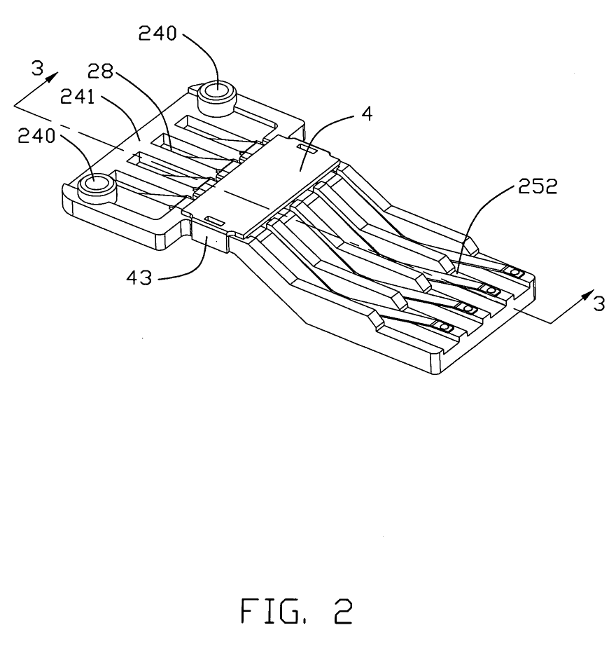

Referring to FIGS. 1-2, a board to board connector 1 comprises an insulating housing 2, a plurality of terminals 3 retained in said insulating housing 2 and a removable cover 4 that is engaged with the insulating housing 2.

Referring to FIGS. 1&4, said insulating housing 2 has a first mating portion 21 located in a first level, a second mating portion 22 located in a second level which is offset from the first level, and a bending portion 23 interconnecting the first mating portion 21 and the second mating portion 22. On the first mating portion 21, the face which is adjacent to the second mating portion 22 is defined as a first mating face 251, and the other relative face is defined as a first base face 241. In the similar way, the face on the second mating portion 22 which is adjacent to the first mating portion 21 is defined as a second mating face 252, and the other relative face is defined as a second base face 242. A plurality of slots 28 are formed on the first mating portion 21 and opening from said first base face 241 to the first mating face 251.

Still referring to FIGS. 1 & 4, Each of said terminals 3 in the shape of longitudinal sheet comprises a first elastic-end 31, a second elastic-end 32 and a engaging portion 33 set between the first elastic-end 31 and the second elastic-end 32, a opening 34 is further formed on said engaging portion 33.

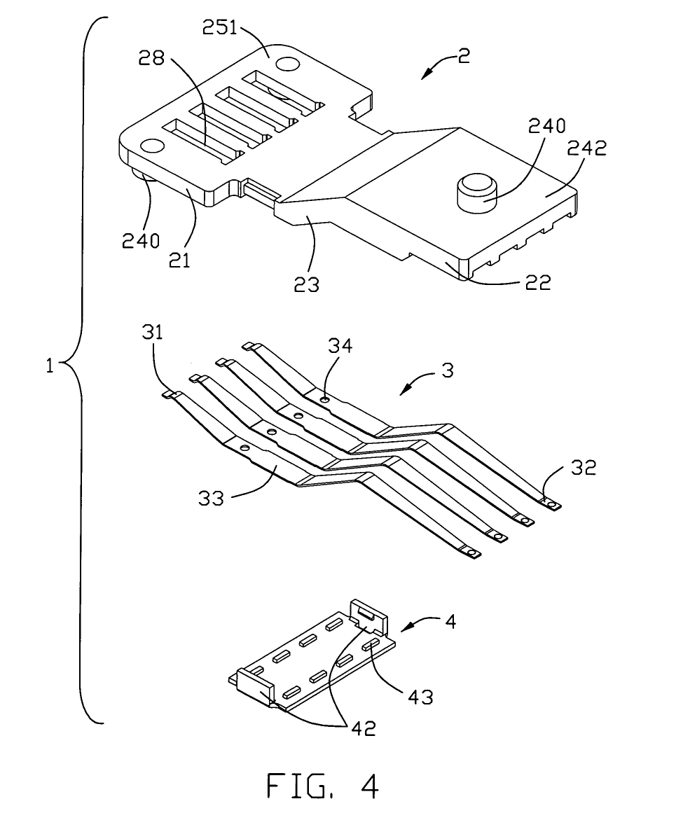

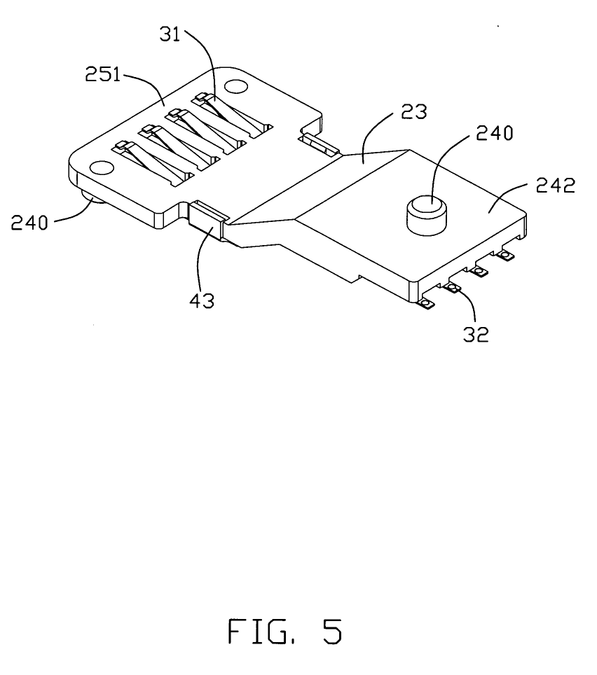

Referring to FIGS. 1-5, Said board to board connector 1 further including a removable cover 4 with a pair of latches 42. When assembling, each of the terminals 3 is lined through the first mating portion 21, the bending portion 23 and the second mating portion 22. Said first elastic-end 31 is protruded on the first mating face 251 through the slots 28, and the second elastic-end 32 is protruded on the second mating face 251. A plurality of ribs 26 are formed on the insulating housing 2, and each of these ribs 26 is lined from the second mating portion 22 to the bending portion 23, which can help positioning the terminals 3 and enhancing the strength of insulating housing 2. Some protrusions 20 are formed on the insulating housing 2 to provide location for corresponding opening 34 on the terminals 3. Then said cover 4 is attached to the insulating housing 2 to help engaging the terminals 3, some press portions 43 are further formed on the cover 4 to hold the terminals 3.

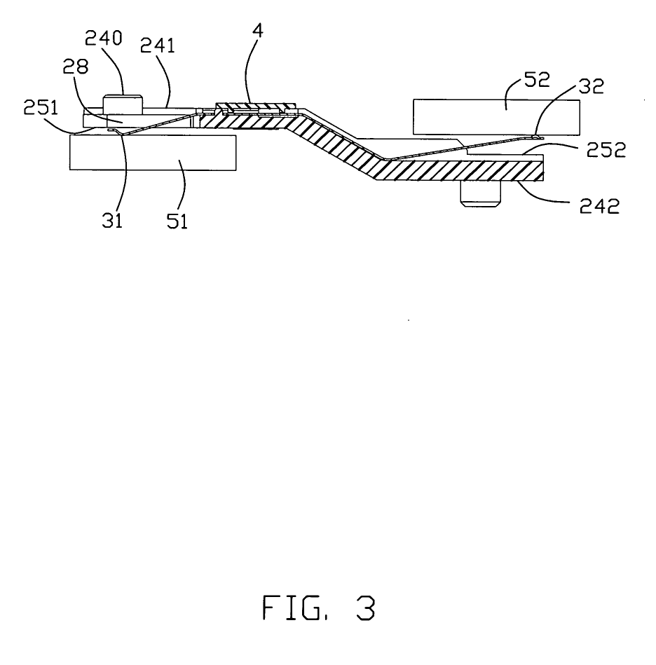

Referring to FIGS. 3, two circuit boards (51, 52) are defined to mate with said first mating face 251 and the second mating face 252. As the first mating face 251 and the second mating face 252 staggered in the mating direction, said boards (51, 52) linked by connector 1 can be located on the mating faces (251, 252) spreadably, so that the total height of board mounting profile can be improved.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

What is claimed is:

1. A board to board connector, comprising:
an insulating housing having a first mating portion located in a first level, and a second mating portion located in a second level which is offset from the first level, a bending portion interconnecting the first mating portion and the second mating portion;
a first mating face defined on the first mating portion adjacent to the second mating portion and a second mating face defined on the second mating portion adjacent to the first mating portion; and
a plurality of terminals, each lined through the first mating portion, the bending portion and the second mating portion, and has a first elastic-end and a second elastic-end protruded on the first mating face and the second mating face separately.

2. The board to board connector as claimed in claim 1, wherein a plurality of slots are formed on the first mating portion, and said first elastic-end are protruded on the first mating face through said slots.

3. The board to board connector as claimed in claim 2, wherein said board to board connector further including a removable cover attached to the insulating housing to help engaging the terminals.

4. The board to board connector as claimed in claim 3, wherein a first base face formed on the other side of the first mating portion relative to the first mating face, and a second base face formed on the other side of the second mating portion relative to the second mating face, positioning portions are defined on both of the first and second mating portion.

5. The board to board connector as claimed in claim 4, wherein each of said terminals further defines a engaging portion between the first elastic-end and the second elastic-end, and a opening is formed on the engaging portion, and corresponding protrusion was defined on the insulating housing.

6. The board to board connector as claimed in claim 5, wherein a plurality of ribs are formed on the insulating housing, which are lined from the second mating portion to the bending portion.

7. The board to board connector as claimed in claim 6, wherein said cover defines a plurality of press portions to hold the terminals.

8. An electrical connector comprising:
an insulative housing defining a retention base and first and second mating regions located on opposite sides of the retention base, said first mating region defining a first mating face facing to an exterior in a first vertical direction and said second mating region defining a second mating face facing to the exterior in a second vertical direction opposite to the first vertical direction;
a plurality of contacts disposed upon the housing, each of said contacts defining a retaining section securely mounted to the retention base and corresponding opposite first and second mating sections extending from opposite ends of the retaining section to the first and second contacting regions, respectively; wherein
the first mating section defines a first mating point extending beyond said first mating face and exposed to said exterior, and said second mating section defines a second mating point extending said second mating face and exposed to the exterior beyond.

9. The electrical connector as claimed in claim 8, wherein said retaining section is securely sandwiched between a cover and the retention region of the housing.

10. The electrical connector as claimed in claim 9, wherein said cover is assembled to the retention region of the housing in a first vertical direction.

11. The electrical connector as claimed in claim 8, wherein the retaining section defines a hole, and one of said cover and said retention region of the housing defines a post extending through said hole.

12. The electrical connector as claimed in claim 8, wherein said first mating region and said second mating region are offset from each other in the vertical direction so as to have the first mating point and said second mating point are located at corresponding levels closer to each other.

13. The electrical connector as claimed in claim 8, wherein said first mating region is further equipped with at least a locating post extending upon a face opposite to said first mating face in said second vertical direction.

14. The electrical connector as claimed in claim 13, wherein said contacts are assembled to the housing in said first direction.

15. The electrical connector as claimed in claim 14, wherein said second mating region is further equipped with at least one locating post extending upon a face opposite to said second mating face in the first vertical direction.

16. The electrical connector as claimed in claim 8, wherein said first mating region defines a plurality of passageways extending therethrough in the first vertical direction, and the contacts are assembled to the housing in said first vertical direction on a face of the retention region which is opposite to the first mating face in the second vertical direction so as to have the mating section extend through the corresponding passageway in the first vertical direction.

17. An electrical connector comprising:
an insulative housing defining a retention base and a first mating region offset from a mounting face of the retention base in a first vertical direction, said first mating region defining a first mating face facing to an exterior in a second vertical direction opposite to said first vertical direction;
a plurality of contacts assembled to the mounting face of the retention base of the housing in said first vertical direction;
a cover assembled to the retention base of the housing is said second vertical direction and cooperating with the retention base of the housing to sandwich the contacts therebetween; wherein
each of said contacts defines a first mating point exposed to said exterior outside of the first mating face while closer to a level where the mounting face of the retention base is located.

18. The electrical connector as claimed in claim 17, wherein the housing is further equipped with a second mating region opposite to the first mating region with a second mating face facing to the exterior in the first vertical direction and opposite to the mounting fac, said second mating region defining a plurality of passageways through which a plurality of spring arms extend to expose corresponding second contact points outside of the second mating face in said first direction.
